(19) United States
(12) Patent Application Publication
(10) Pub. No.: US 2019/0043324 A1
(43) Pub. Date: Feb. 7, 2019

(54) A VOLUMETRIC OCCUPANCY COUNTING SYSTEM

(71) Applicant: Carrier Corporation, Palm Beach Gardens, FL (US)

(72) Inventors: Sameh Dardona, South Windsor, CT (US); Yan Zhang, Newington, CT (US); Joseph V. Mantese, Ellington, CT (US); Nicholas Charles Soldner, Southbury, CT (US); Vijaya Ramaraju Lakamraju, Avon, CT (US)

(21) Appl. No.: 16/073,179

(22) PCT Filed: Jan. 20, 2017
(86) PCT No.: PCT/US2017/014219

§ 371 Date: Jul. 26, 2018

Related U.S. Application Data
(60) Provisional application No. 62/287,257, filed on Jan. 26, 2016.

(51) Int. Cl. G08B 13/191; G01J 5/00; G02B 3/08; G01J 5/34

(52) U.S. Cl. CPC G08B 13/191; G01J 5/34; G02B 3/08; G01J 5/0025

(57) ABSTRACT

A volumetric occupancy counting system that may be applied to a security system of a building management system includes a focal plane array (62) and a Fresnel lens (75). The focal plane array has a plurality of radiant energy sensors (82) configured to convert radiant energy into an electrical signal. The Fresnel lens has a plurality of lenslets (02) each including a focal length configured to map one occupant into a pre-determined number of radiant energy sensors of the plurality of radiant energy sensors.

### BACKGROUND

The present disclosure relates to a volumetric occupancy counting system, and more particularly to pyroelectric array sensors operatively coupled with a Fresnel lens.

Ensuring safety and efficient energy management in, for example, buildings require accurate counting of building occupants. In traditional occupancy counting applications, a device may be used to quantify the number and direction of occupants traversing, for example, an entrance or exit point. The accuracy and resolution of such a device may depend on the employed technology. Different forms of technologies have been used in developing occupancy counting devices, such as infrared/laser beams and thermal cameras. Unfortunately, such known devices are high in cost, require considerable energy, and are low in accuracy.

Traditionally, simpler passive infrared (PIR) devices may be used to sense ingress into a room. These devices work by outfitting a pyroelectric sensor composed of two or more sensing elements (i.e., pixels) with a modified multi-component lens that may direct infrared radiation alternately between the various sensing elements. Such devices may offer activation only with motion, a relatively low in cost, require low energy, and do not require any extraneous lighting to make them effective. Unfortunately, such traditional PIR devices may not be capable of people counting.

### SUMMARY

A volumetric occupancy counting system according to one, non-limiting, embodiment of the present disclosure includes a focal plane array including a plurality of radiant energy sensors configured to convert radiant energy into an electrical signal; and a Fresnel lens having a plurality of lenslets each including a focal length configured to map one occupant into a pre-determined number of radiant energy sensors of the plurality of radiant energy sensors.

Additionally to the foregoing embodiment, the pre-determined number of radiant energy sensors is one.

In the alternative or additionally thereto, in the foregoing embodiment, each one of the plurality of lenslets has a field of view configured to project upon all of the plurality of radiant energy sensors.

In the alternative or additionally thereto, in the foregoing embodiment, each one of the plurality of lenslets has a field of view configured to project upon all of the plurality of radiant energy sensors.

In the alternative or additionally thereto, in the foregoing embodiment, each occupant is captured by a single, respective, lenslet of the plurality of lenslets in any given moment of time.

In the alternative or additionally thereto, in the foregoing embodiment, the plurality of lenslets form at least one ring with each lenslet disposed circumferentially adjacent to another lenslet of the plurality of lenslets.

In the alternative or additionally thereto, in the foregoing embodiment, the at least one ring comprises a first ring having a first radius and a second ring having a second radius that is less than the first radius, and the first and second rings are concentrically disposed to one-another.

In the alternative or additionally thereto, in the foregoing embodiment, the first ring has less lenslets of the plurality of lenslets than the second ring.

In the alternative or additionally thereto, in the foregoing embodiment, a ratio of the number of radiant energy sensors to the number of lenslets is about 0.14.

In the alternative or additionally thereto, in the foregoing embodiment, the focal plane array is a four-by-four focal plane array.

In the alternative or additionally thereto, in the foregoing embodiment, the Fresnel lens is disposed and generally centered to a top of a space being monitored and the first ring is disposed above the second ring.

In the alternative or additionally thereto, in the foregoing embodiment, the Fresnel lens is disposed and generally centered to a top portion of a space being monitored and the size of each lenslet of the plurality of lenslets is chosen to proven sufficient signal to noise ratio at a horizontal radius of about five meters from a center of the space.

In the alternative or additionally thereto, in the foregoing embodiment, the Fresnel lens is made of molded plastic.

A method of operating a volumetric occupancy counting system according to another, non-limiting, embodiment includes detecting a first occupant within a field of view of a first lenslet of a Fresnel lens in a given moment in time; detecting a second occupant with a field of view of a second lenslet of the Fresnel lens in the given moment in time; projecting the first occupant upon an entire pyroelectric array; and projecting the second occupant upon the entire pyroelectric array.

Additionally to the foregoing embodiment, the method includes tracking the first and second occupants utilizing an algorithm executed by a computer-based processor of the volumetric occupancy counting system.

In the alternative or additionally thereto, in the foregoing embodiment, the first and second occupants each energize only one respective pixel of the pyroelectric array in any given moment in time.

In the alternative or additionally thereto, in the foregoing embodiment, the pyroelectric array comprises a material that responds only to moving occupants.

In the alternative or additionally thereto, in the foregoing embodiment, the method includes counting a number of occupants including the first and second occupants via the computer-based processor.

In the alternative or additionally thereto, in the foregoing embodiment, the volumetric occupancy counting system is part of a security system.

In the alternative or additionally thereto, in the foregoing embodiment, an algorithm is configured to compare radiant energy strength and motion over a period of time to discriminate potential target overlap

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of a building management system utilizing a volumetric occupancy counting (VOC) system of the present disclosure;

FIG. 2 is a schematic of the VOC system;

FIG. 3 is a perspective and partially exploded view of a local detection device of the VOC system;

FIG. 4 is a perspective view of components of the detection device integrated into a common substrate platform; and

FIG. 5 is a perspective view of a space monitored by the local detection device.

### DETAILED DESCRIPTION

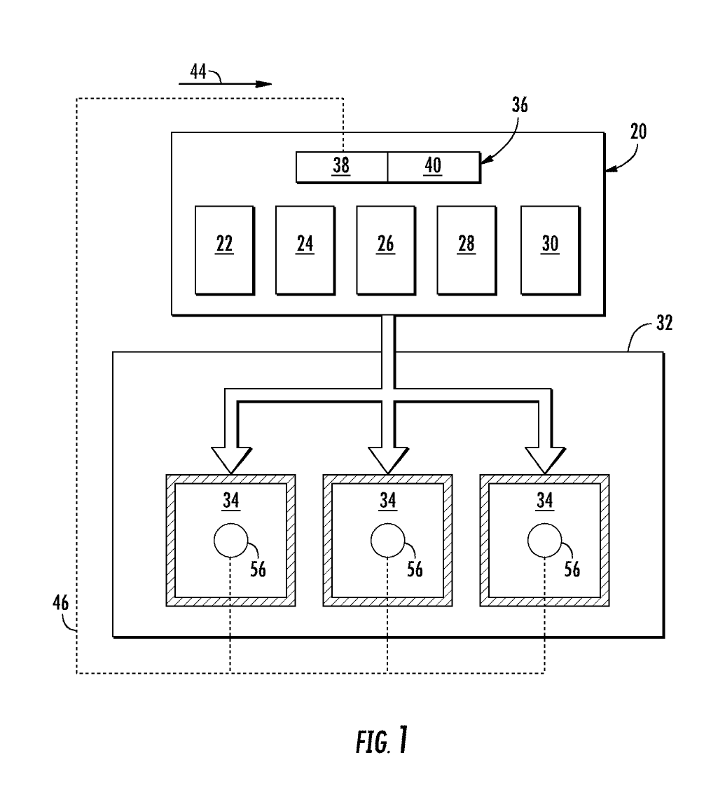

Referring to FIG. 1, a building management system 20 of the present disclosure is illustrated. The building management system 20 may include at least one of an ambient air temperature control system 22, a security system 24 (i.e., intrusion system), a lighting or illumination system 26, a transportation system 28 a safety system 30 and others. Each system 22, 24, 26, 28, 30 may be associated with and/or contained within a building 32 having a plurality of predefined spaces 34 that may generally be detached or substantially isolated from one-another, may be accessible and/or interconnected via a door and/or through hallways (not shown) and other means.

The ambient air temperature control system 22 may be a forced air system such as a heating, ventilation, and air conditioning (HVAC) system, a radiant heat system and others. The security system 24 may be configured to detect intruders and provide various forms of alerts and notifications. The lighting system 26 may control and/or monitor lighting in each one of the predefined spaces 34 based on any number of factors including natural background lighting, occupancy and others. The transportation system 28 may include the control and/or monitoring of elevators, escalators and other transportation devices associated with and/or within the building 32. The safety system 30 may include the detection of conditions that may pose a risk or health hazard to occupants of the building 32. All of these systems 22, 24, 26, 28, 30 may require a variety of devices to perform any variety of functions including detection, monitoring communication, data referencing and collection, user control and others. Many devices may be shared between systems.

The building management system 20 may further include a computing device 36 that controls and/or supports each system 22, 24, 26, 28, 30. The computing device 36 may include a processor 38 (e.g., microprocessor) and a computer readable and writeable storage medium 40. It is further contemplated and understood that the building management system 20 may include more than one computing device 36 with any one computing device being dedicated to any one of the systems 22, 24, 26, 28, 30.

The building management system 20 includes a volumetric occupancy counting (VOC) system 42. The VOC system 42 may utilize low cost and low resolution sensors assisted by computer vision algorithms to accurately detect, track and count moving occupants (e.g., people) in a given space 34 using minimal energy consumption. In one embodiment, the VOC system 42 may supplement functions of the building management system 20 (e.g., HVAC system 22, lighting system 26, security system 24 and others). For example, the computing device 36 may receive a signal (see arrow 44) over a wired or wireless pathway(s) 46 from the VOC system 42 indicative of a number of intruders in a given space 34. Upon such a signal 44, the computing device 36 may output a command signal (not shown) to the security system 24 for initiating a security response that may be an alert, an alarm and/or other initiations.

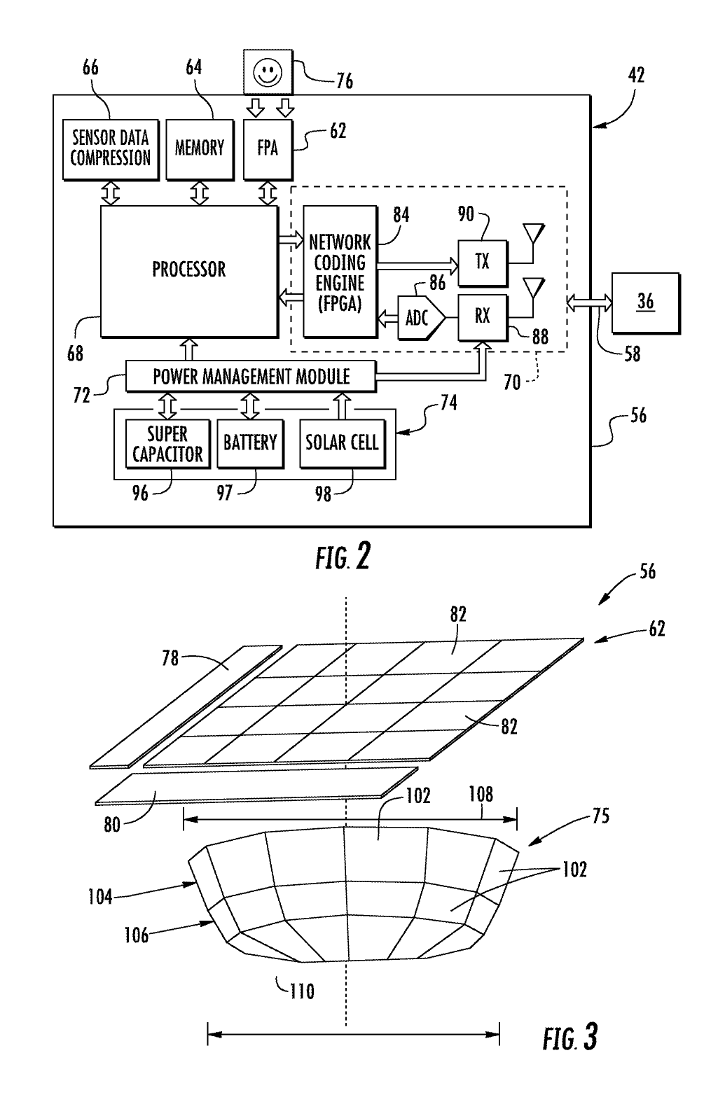

Referring to FIGS. 2 and 3, the VOC system 42 may include a plurality of local detection devices 56 with at least one detection device located in each space 34. The detection devices 56 may be configured to communicate with the computing device 36 over the pathways 46. Each detection device 56 may be configured to monitor substantially all of the respective space 34 for detection, tracking and counting of the occupants. To monitor the entire space 34, each detection device 56 may be located in a top portion of the space 34 (e.g., mounted to a ceiling) and may be substantially centered to the top portion or upon the ceiling. Each detection device 56 may include a pyroelectric focal plane array (FPA) 62 that may be low resolution, a memory module 64, a sensor data compression block 66, a processor 68, a communication module 70, a power management module 72, a power source 74, and a lens 75 that may be a Fresnel lens.

The pyroelectric FPA 62 may be an infrared FPA configured to sense and detect radiated heat emitted by the occupants. The FPA 62 is ‘low resolution’ because it may include only about sixteen pixels. The space 34 is a ‘large’ space relative to the low resolution FPA 62 (i.e., relatively low number of pixels). The FPA 62 may include a row decoder 78, a column decoder 80 (which are part of the Read-Out Integrated Circuit (ROIC)), and a plurality of pixels or sensors 82 that may be infrared sensors arranged in a series of rows and columns (i.e., four rows and four columns illustrated in FIG. 3). The row and column decoders 78, 80 are electrically coupled to the respective rows and columns of the sensors 82, and are configured to receive intensity information (e.g., heat intensity) recorded over a time interval. As one example, the sensors 82 may be configured to sense radiated energy having an infrared, long, wavelength that may be within a range of about three (3) to fifteen (15) micrometers. This range is a thermal imaging region, in which the sensors 82 may obtain a passive image of the occupants only slightly higher than, for example, room temperature. This image may be based on thermal emissions only and may require no visible illumination.

The memory module 64 of the detector device 56 is generally a computer readable and writeable storage medium and is configured to communicate with the processor 68 and generally stores intensity data from the sensors 82 for later processing, stores executable programs (e.g., algorithms) and their associated permanent data as well as intermediate data from their computation. The memory module 64 may be a random-access memory (RAM) that may be a ferroelectric RAM (FRAM) having relatively low power consumption with relatively fast write performance, and a high number of write-erase cycles. It is further contemplated and understood that the VOC system 54 may be integrated in-part with the computing device 36 that may also perform, at least in-part, a portion of the data processing of data received from the FPA 62.

The radiant energy intensity information/data received by the decoders 78, 80 may be conditioned via a signal conditioning circuit (not shown) and then sent to the processor 68. The signal conditioning circuit may be part of the ROIC. Signal conditioning may include analog-to-digital converters and other circuitry to compensate for noise that may be introduced by the sensors 82. The processor 68 may be configured to provide focal plane scaling of the intensity value data received from the signal condition circuit and may further provide interpolation techniques generally known in the art. The processor 68 is generally computer-based, and examples may include a post-processor, a microprocessor and/or a digital signal processor.

The sensor data compression block 66 of the detector device 56 is known to one having skill in the art and is generally optional with regard to the present disclosure.

The communication module 70 of the detection device 56 is configured to send and receive information and commands relative to the operation of the detection device 56. The communication module 70 may include a network coding engine block 84, an ADC 86, a receiver 88 (e.g. wireless), and a transmitter 90 (e.g., wireless). As is well-known in the art, the transmitter and receiver may be implemented as a transceiver or could be replaced by a well-known wired communication link (not shown). The network coding engine block 84 is configured to interface the input and output of the processor 68 to transmitter 90, receiver 88 (through ADC 86), provide encoding (e.g., for error detection and correction), security via encryption or authentication, and other features.

The ADC 86 of the detection device 56 is configured to convert received analog information to digital information for eventual use by the processor 68. The network coding engine 84 provides any decoding necessary for error detection and correction, and/or security.

The receiver 88 and the transmitter 90 of the detection device 56 are configured to respectively receive and transmit communications to and from other systems or components such as the computing device 36 of the building management system 20 and/or the HVAC system 22. Such communications may be conducted over pathways that may be wired or wireless.

The power management module 72 of the detection device 56 is configured to control the power acquisition and power consumption of the detection device 56 by controlling both the power source 74 and power consuming components. Such power consuming components may include the processor 68, the optional data compression block 66, the memory 64, the FPA 62 and the communication module 70 (e.g., transmitter 90, receiver 88, and ADC 86). It is contemplated and understood that other energy consuming components of the detection device 56 may be controlled. Such control may simultaneously maintain the detection device 56 functionality while maximizing life (i.e., the length of time the detection device 56 can remain functional). In one embodiment, this control is achieved by receding horizon control (optimization). In alternative embodiments other control strategies such as model predictive control may be used.

The power source 74 of the detection device 56 provides power to the other components of the device, and may include at least one of a super capacitor 96, a battery 97 and a solar cell 98. The power management module 72 is configured to draw power from any one of the power sources as dictated by the needs of the system. The power management module 72 may also facilitate a power scheduling function that controls the simultaneous use of the various on-chip component functions to minimize unwanted current spikes. It is contemplated and understood that other short-term energy storage devices may be used in place of the super capacitor 96, other long-term energy storage devices may be used in place of the battery 97, and other energy harvesting or recharging devices may be used in place of the solar cell 98 including power from a power grid.

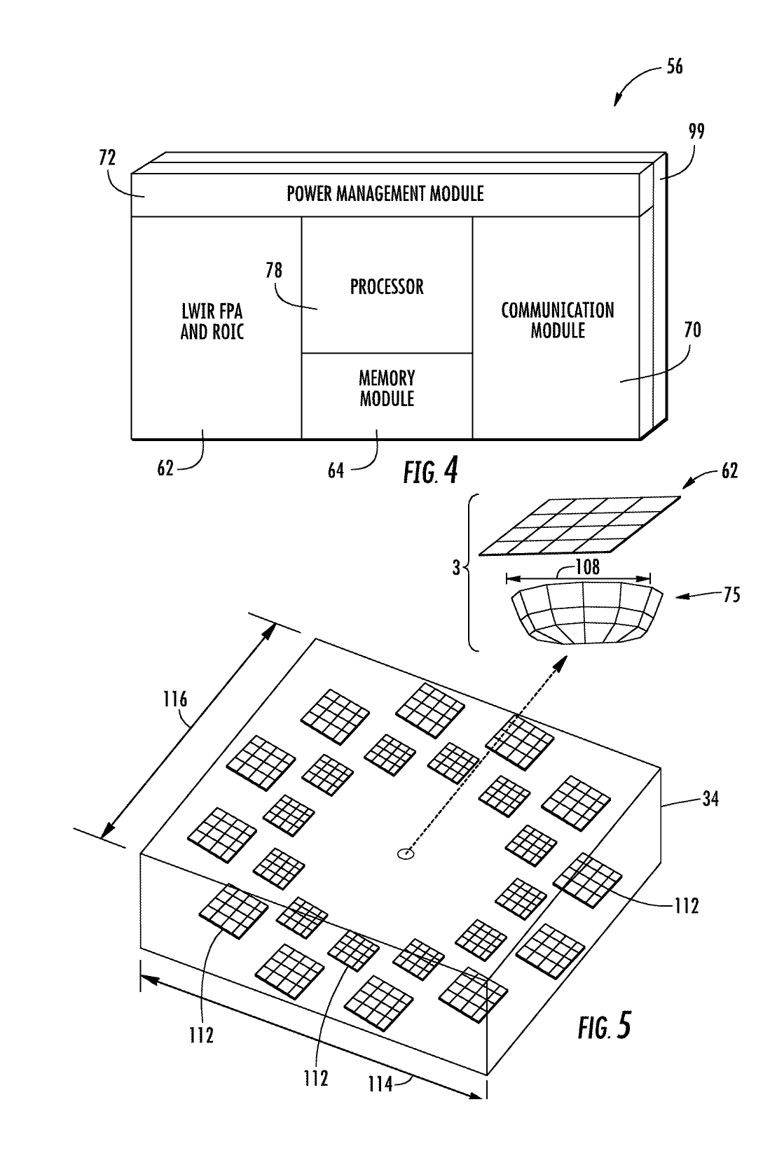

Referring to FIG. 4, the FPA 62 (including the ROIC), the memory module 64, the processor 68, the power management module 72 and the communication module 70 may generally be integrated together on a single substrate platform or chip 99 that may be silicon-based. More specifically, the components may generally share the focal plane of the FPA 62. Together, the integrated components may be aimed toward minimal power consumption, small overall size/weight and low cost. Integration of these components may be further enhanced via a power scheduling function conducted by the power management module 72 as well as coordinated design of the individual functions of each component to work harmoniously. That is, the power scheduling function may, for example, minimize unwanted current spikes by controlling the simultaneous use of the various on-chip components functions.

By placing individual subsystem components on the same die or substrate platform 99, signal integrity, resistive losses and security is generally improved through elimination of interconnects and sources of extraneous electrical and radiative noise typically present in systems with similar functionality but that use several individually packaged integrated circuits (IC's). Moreover, by placing all components on the same substrate platform 99, economy of scale is achieved that enables chip-scale cost reduction. Yet further, power management and consumption may be optimized potentially achieving long life battery operation, and facilitating packaging of various circuitry components on a single substrate platform 99. The detection device 56 may be built upon a ferroelectric memory platform using either active or passive detection; and, may be built upon a thermal isolator rather than a MEMS bridge, thereby improving yield, reducing across device response variations, and may be compatible with wafer production having small feature sizes.

Referring to FIGS. 3 and 5, the Fresnel lens 75 may be segments into a plurality of lenslets 102 arranged to detect and count a plurality of occupants entering and leaving the associated space 34. The lenslets 102 may be arranged over, for example, two rings 104, 106. The rings 104, 106 may be substantially concentric to one-another with the first ring 104 disposed adjacent to and above the second ring 106. The first ring 104 may have a diameter (see arrow 108) that is greater than a diameter (see arrow 110) of the second ring 106. The field of view of each lenslet 102 may be projected at substantially the entire FPA 62, and the focal length of each lenslet 102 may be designed to map one person into about one sensor 82. Such a mapping ratio may eliminate signal overlap from occupants located closely to one-another and may provide a high counting accuracy. The size of each lenslet 102 may be chosen to provide a sufficient signal-to-noise ratio at a pre-determined horizontal radius from the center of the room. It is further contemplated that the lenslets may be distributed across a hemispherical shape. The lens 75 may be made of molded plastic.

Tracking algorithms may be used and executed by the processor 68 to estimate the number of occupants and track their movements within the field of view of the lenslets 102, with each occupant contained or captured by, for example, a single lenslet 102. The Fresnel lens 75 is constructed and arranged so that an occupant moving within the field of view of any lenslet 102 may only activate, for example, a single sensor 82 in the FPA 62 at any moment in time. Activating only a single sensor 82 by a single occupant in any moment in time will significantly reduce the complexity of occupant tracking.

Moreover, the pyroelectric materials used in making the sensors 82 may only respond to moving objects and/or occupants, thus minimizing or eliminating signals resulting from background clutter. More specifically, after a heating or cooling effect, pyroelectric materials generate a temporary voltage. The change in temperature shifts the positions of material atoms slightly within the pyroelectric crystal structure, such that the polarization (i.e., electric field direction) of the material changes. This polarization change gives rise to a voltage across the crystal substrate. If the temperature remains constant at its new value, the pyroelectric voltage gradually disappears due to leakage current losses. Examples of pyroelectric materials that respond only to moving objects and/or occupants may include: Lithium Tantalate (LiTaO₃), Strontium Barium Niobate (SrBaNb₂O₆), Zinc Oxide, Lead Zirconate Titanate (PZT), and others. Occupants that are initialized within the field of view and establish trackable motion within the array may be tracked and counted. Targets that are initialized in one of the sensors 82 and that do not establish movement within the array 62 will not be tracked by the algorithm.

Referring to FIG. 5, an example of the detector device 56 arranged to detect, track and count occupants in a space 34 is illustrated. Each lenslet 102 of the Fresnel lens 75 is configured with a focal length designed to monitor a pre-designated portion 112 of the space 34. That portion 112 may be projected across the entire FPA 62. In this example, the space or room 34 may have a width 114 and depth 116 of about ten (10) meters with a height 118 of about two and a half (2.5) meters. The diameter 108 of the top ring 104 may be about 10.2 millimeters with about twelve lenslets 102 distributed circumferentially about the top ring 104 and about twelve lenslets 102 distributed circumferentially about the bottom ring 106. The FPA 62 may be a four-by-four array, thus having sixteen sensors 82.

Benefits of the present disclosure include a low cost detector device 56 (i.e., a FPA of few sensors and a lens made of plastic), a device that utilizes little energy since the sensors are only activated by the detection circuit when an occupant moves within the device's field of view, and a simplified tracking and counting algorithm that provides high accuracy.

While the present disclosure is described with reference to exemplary embodiments, it will be understood by those skilled in the art that various changes may be made and equivalents may be substituted without departing from the scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A volumetric occupancy counting system comprising:
a focal plane array including a plurality of radiant energy sensors configured to convert radiant energy into an electrical signal; and
a Fresnel lens having a plurality of lenslets each including a focal length configured to map one occupant into a pre-determined number of radiant energy sensors of the plurality of radiant energy sensors.

2. The volumetric occupancy counting system set forth in claim 1, wherein the pre-determined number of radiant energy sensors is one.

3. The volumetric occupancy counting system set forth in claim 1, wherein each one of the plurality of lenslets has a field of view configured to project upon all of the plurality of radiant energy sensors.

4. The volumetric occupancy counting system set forth in claim 2, wherein each one of the plurality of lenslets has a field of view configured to project upon all of the plurality of radiant energy sensors.

5. The volumetric occupancy counting system set forth in claim 1, wherein each occupant is captured by a single, respective, lenslet of the plurality of lenslets in any given moment of time.

6. The volumetric occupancy counting system set forth in claim 1, wherein the plurality of lenslets form at least one ring with each lenslet disposed circumferentially adjacent to another lenslet of the plurality of lenslets.

7. The volumetric occupancy counting system set forth in claim 6, wherein the at least one ring comprises a first ring having a first radius and a second ring having a second radius that is less than the first radius, and the first and second rings are concentrically disposed to one-another.

8. The volumetric occupancy counting system set forth in claim 7, wherein the first ring has less lenslets of the plurality of lenslets than the second ring.

9. The volumetric occupancy counting system set forth in claim 8, wherein a ratio of the number of radiant energy sensors to the number of lenslets is about 0.14.

10. The volumetric occupancy counting system set forth in claim 9, wherein the focal plane array is a four-by-four focal plane array.

11. The volumetric occupancy counting system set forth in claim 7, wherein the Fresnel lens is disposed and generally centered to a top of a space being monitored and the first ring is disposed above the second ring.

12. The volumetric occupancy counting system set forth in claim 10, wherein the Fresnel lens is disposed and generally centered to a top portion of a space being monitored and the size of each lenslet of the plurality of lenslets is chosen to proven sufficient signal to noise ratio at a horizontal radius of about five meters from a center of the space.

13. The volumetric occupancy counting system set forth in claim 1, wherein the Fresnel lens is made of molded plastic.

14. A method of operating a volumetric occupancy counting system comprising:
detecting a first occupant within a field of view of a first lenslet of a Fresnel lens in a given moment in time;
detecting a second occupant with a field of view of a second lenslet of the Fresnel lens in the given moment in time;
projecting the first occupant upon an entire pyroelectric array; and
projecting the second occupant upon the entire pyroelectric array.

15. The method set forth in claim 14 further comprising:
tracking the first and second occupants utilizing an algorithm executed by a computer-based processor of the volumetric occupancy counting system.

16. The method set forth in claim 15, wherein the first and second occupants each energize only one respective pixel of the pyroelectric array in any given moment in time.

17. The method set forth in claim 16, wherein the pyroelectric array comprises a material that responds only to moving occupants.

18. The method set forth in claim 16 further comprising:
counting a number of occupants including the first and second occupants via the computer-based processor.

19. The method set forth in claim 18, wherein the volumetric occupancy counting system is part of a security system.

20. The method set forth in claim 16, wherein an algorithm is configured to compare radiant energy strength and motion over a period of time to discriminate potential target overlap.
